(19) United States
(12) Patent Application Publication
(10) Pub. No.: US 2022/0058678 A1
(43) Pub. Date: Feb. 24, 2022

(54) REWARD VESTING AND MANAGEMENT

(71) Applicant: Wells Fargo Bank, NA, San Francisco, CA (US)

(72) Inventors: Craig A. Coffey, San Francisco, CA (US); Dana Roytenberg, San Francisco, CA (US); Matt S. Rogers, San Francisco, CA (US)

(21) Appl. No.: 15/243,845

(22) Filed: Aug. 22, 2016

(51) Int. Cl. G06Q 30/02

(52) U.S. Cl. CPC G06Q 30/0216

(57) ABSTRACT

Systems, methods, and apparatuses for managing rewards earned by a user are provided. A method includes receiving, by a financial institution computing system, at least one reward parameter corresponding to an action of a user, determining, by the financial institution computing system, a reward based on the at least one reward parameter, and vesting, by the financial institution computing system, two or more portions of the reward at different times over a vesting period.

### TECHNICAL FIELD

Arrangements of the present disclosure relate to managing a reward that vests over a vesting period.

### BACKGROUND

Financial institutions typically award customers using financial products and services of the financial institutions with various types of rewards to deepen relationships and to incentivize loyalty. For instance, based on certain customer behaviors such as opening a new account or spending above a threshold on a designated credit card, rewards may be given. The reward may represent utility which the customers may appreciate, thus enticing the customers to further use the financial products and services.

### SUMMARY

Examples described herein relate to managing rewards, including, but not limited to, receiving, by a financial institution computing system, at least one reward parameter corresponding to an action of a user, determining, by the financial institution computing system, a reward based on the at least one reward parameter, and vesting, by the financial institution computing system, two or more portions of the reward at different times over a vesting period.

In some examples, a method for managing rewards includes sending, by a user device to a financial institution computing system, at least one reward parameter corresponding to an action of a user; and receiving, by the user device from the financial institution computing system, information related to a reward determined based on the at least one reward parameter, wherein two or more portions of the reward vest at different times over a vesting period.

According to some examples, a financial institution computing system associated with a financial institution includes a network interface structured to facilitate data communication via a network, a memory, and a processing circuit comprising a processor, the processing circuit configured to receive at least one reward parameter corresponding to an action of a user, determine a reward based on the at least one reward parameter, and vest two or more portions of the reward at different times over a vesting period.

These and other features, together with the organization and manner of operation thereof, will become apparent from the following detailed description when taken in conjunction with the accompanying drawings.

### BRIEF DESCRIPTION OF THE FIGURES

FIG. 1 is a diagram of an example of a computing system for managing rewards according to some arrangements.

FIG. 2 is a diagram of an example of a reward vesting circuit according to some arrangements.

FIG. 3 is a flow diagram illustrating an example of a reward vesting management method according to various arrangements.

FIG. 4 is a diagram illustrating an example of the reward vesting management method of FIG. 3 in some arrangements.

FIG. 5 is a flow diagram illustrating an example of a reward vesting management method featuring vesting by trigger events according to various arrangements.

FIG. 6 is a flow diagram illustrating an example of a reward vesting management method featuring vesting based on a vesting schedule according to various arrangements.

FIG. 7 is a diagram illustrating an example of the reward vesting management method of FIG. 6 in some arrangements.

FIG. 8 is a flow diagram illustrating an example of a reward vesting management method performed by a user device according to various arrangements.

FIG. 9 is a flow diagram illustrating an example of a reward vesting management method performed by a user device according to various arrangements.

FIG. 10 is a diagram of an example of a display user interface outputted by an input/output logic of a user device presenting information related to vesting rewards.

FIG. 11 is a diagram of an example of a display user interface outputted by an input/output logic of a user device presenting information related to vesting rewards.

FIG. 12 is a diagram of an example of a display user interface outputted by an input/output logic of a user device presenting information related to vesting rewards.

### DETAILED DESCRIPTION

Referring to the FIGS. generally, systems, methods, and apparatuses for vesting and managing rewards are described herein. In particular, an earned reward is delivered or vests in a vesting period based on customer relationships and behaviors over time. That is, instead of allowing the entirety of the reward to be collected as soon as the reward is earned, the reward is partitioned into two or more portions the vest over time or vest upon actions by the customer. Each of the two or more portions vests or otherwise is allowed to be collected subsequent to earning the reward. In other arrangements, one portion vests as soon as the entire reward is earned. Illustrating with a non-limiting example, a customer earns 100,000 points in response to selecting, via a user device, to onboard (e.g., sign up for) a new offering for a financial product (e.g., a credit card). Instead of allowing the customer to immediately collect the 100,000 points, the 100,000 points are partitioned into 4 portions of 25,000 points each. One of the portions vests every year over a vesting period of 4 years. Before a portion vests, that portion cannot be collected or otherwise used by the customer.

In some arrangements, one or more of the portions vest based on a vesting schedule, which indicates at least one an amount of each of the partitioned portions and vesting time associated with each of the portions. In some arrangements, one or more of the portions vest in response to detecting at least one suitable trigger event. The trigger event corresponds to customer actions in addition to the customer action based on which the reward is earned. The reward vests based on the vesting schedule, the trigger event, or a combination thereof.

Accordingly, vesting rewards as disclosed herein may support ongoing customer relationships with an added time dimension given that in order to benefit from the reward, the customer is motivated to perform additional acts (corresponding to trigger events) or at least continue to be a customer to obtain portions of the reward yet to vest. As such, profitability of the financial institution sponsoring the vesting rewards can align with ongoing customer incentives and loyalty.

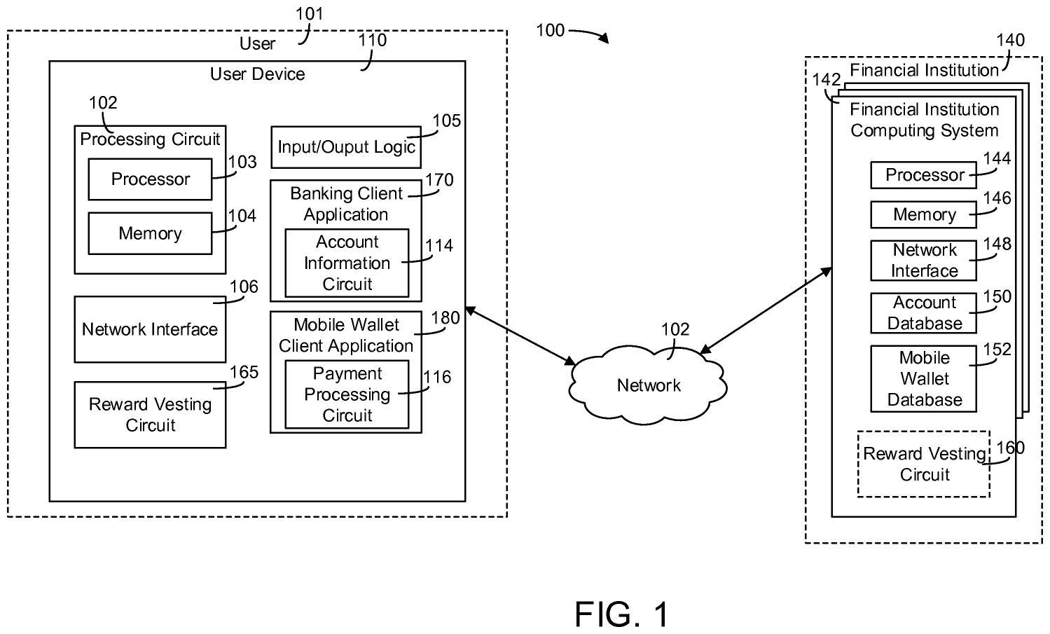

Referring now to FIG. 1, a block diagram of a computing system 100 for managing rewards is shown according to some arrangements. As described herein, the computing system 100 facilitates determining and vesting rewards earned by a customer (i.e., a user 101). As shown, the computing system 100 includes at least one user device 110 associated with the user 101 and at least one financial institution 140 having an associated financial institution computing system 142. The user device 110 and the financial institution computing system 142 is communicably and operatively coupled to each other over a network 102. The network 102 is any suitable type of network. For example, the network 102 is a wireless network interface (e.g., 802.11X, ZigBee, Bluetooth, Internet, etc.), a wired network interface (e.g., Ethernet), or any combination thereof. In some arrangements, the network 102 includes the Internet. The network 102 is structured to permit the exchange of data, values, instructions, messages, and the like between and among the user device 110 and the financial institution computing system 142.

As shown, the financial institution 140 provides financial products and services with the financial institution computing system 142. The financial institution computing system 142 includes a processor 144 and a memory device 146. The processor 144 is implemented as a general-purpose processor, an Application Specific Integrated Circuit (ASIC), one or more Field Programmable Gate Arrays (FPGAs), a Digital Signal Processor (DSP), a group of processing components, or other suitable electronic processing components. The memory 146 (e.g., Random Access Memory (RAM), Read-Only Memory (ROM), Non-volatile RAM (NVRAM), Flash Memory, hard disk storage, etc.) stores data and/or computer code for facilitating at least some of the various processes described herein. In this regard, the memory 146 stores programming logic that, when executed by the processor 144, controls the operation of the financial institution computing system 142.

As shown, the financial institution computing system 142 includes a network interface 148. The network interface 148 is structured for sending and receiving of data over the network 102 (e.g., to and from the user device 110, etc.). The financial institution computing system 142 includes an account database 150 that stores customer information and account information relating to one or more accounts held by the user 101 with the financial institution 140. In this regard and as mentioned, more than one financial institution (such as, but not limited to, the financial institution 140) with an associated financial institution computing system (such as, but not limited to, the financial institution computing system 142) is communicably coupled to the components of FIG. 1 over the network 102 to access accounts held by the user 101 in such financial institutions. As further shown, the financial institution computing system 142 includes a mobile wallets account database 152 for storing mobile wallet accounts of users, including the user 101. As described herein, the mobile wallet accounts permit payments via the mobile wallet client application 180.

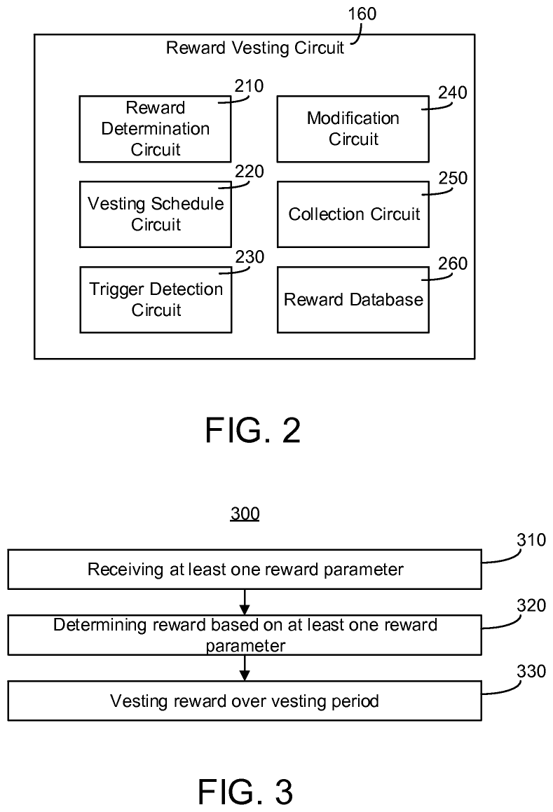

The financial institution computing system 142 includes a reward vesting circuit 160. The reward vesting circuit 160 is configured to perform one or more of determining a reward, determining a vesting schedule of the reward, determining a trigger event causing a portion of the reward to vest, modifying one or more of a length of the vesting period, vesting time at which a portion of the reward vests, amount of an unvested remainder of the reward, amount of a portion of the reward yet to vest, or the like. An example of the reward vesting circuit 160 is set forth with respect to FIG. 2.

In some examples, the reward vesting circuit 160 is implemented within the processor 144. For example, the reward vesting circuit 160 is implemented as a software application stored within the memory 146 and executed by the processor 144. Accordingly, such examples can be implemented with minimal additional hardware costs. However, other examples relate to apparatuses and methods implemented with dedicated hardware specifically configured for performing operations described herein with respect to the reward vesting circuit 160. For example, the reward vesting circuit 160 is implemented with a processing component separate from the processor 144.

As shown, the user 101 operates or is associated with the user device 110. The user 101 includes individuals, business representatives, large and small business owners, and any other entity. In some configurations, the user 101 has at least one financial account at the financial institutions 140. The user device 110 is a mobile device. The mobile device includes any wearable device. Wearable devices refer to any type of device that a user can wear, including, but not limited to, a watch (e.g., a smart watch), glasses (e.g., eye glasses, sun glasses, smart glasses, etc.), bracelet (e.g., a smart bracelet), etc. The mobile device includes, but not limited to, a phone (e.g., a smartphone, etc.) and a computing device (e.g., a tablet computer, a laptop computer, a person digital assistant, etc.). In some examples, the user device 110 is a computing device such as, but not limited to, a desktop computer, server, or other types of computing device. Accordingly, the user device 110 includes a display device (e.g., a screen) and one or more input/output devices (e.g., a touch screen, microphone, speaker, keyboard, etc.) for receiving user input from the user 101 and/or outputting information to the user 101.

In some arrangements, the user device 110 includes a processing circuit 102 having a processor 103 and a memory 104. The processor 103 is implemented as a general-purpose processor, an ASIC, one or more FPGAs, a DSP, a group of processing components that are distributed over various geographic locations or housed in a single location or device, or other suitable electronic processing components. The memory 104 (e.g., RAM, NVRAM, ROM, Flash Memory, hard disk storage, etc.) stores data and/or computer code for facilitating the various processes described herein. Moreover, the memory 104 is or include tangible, non-transient volatile memory or non-volatile memory. Accordingly, the memory 104 includes database components, object code components, script components, or any other type of information structure for supporting the various activities and information structures described herein.

The user device 110 is shown to include various circuits and logic for completing at least some of the activities described herein. More particularly, the user device 110 includes an input/output logic 105, network interface 106, mobile wallet client application 180, banking client application 170, and reward vesting circuit 165. While various circuits, interfaces, and logic with particular functionality are shown, it should be understood that the user device 110 includes any number of circuits, interfaces, and logic for completing the functions described herein. For example, the activities of multiple circuits are combined as a single circuit and implemented on a same processing circuit (e.g., the processing circuit 102), as additional circuits with additional functionality are included, etc.

The network interface 106 is configured for and structured to establish a communication session via the network 102 with the financial computing system 142. Accordingly, the network interface 106 includes any of a cellular transceiver (e.g., Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS) Wideband Code Division Multiple Access (WCDMA), Long Term Evolution (LTE), evolved Multimedia Broadcast Multicast Services (eMBMS), High-Speed Downlink Packet Access (HSDPA), and the like), Universal Terrestrial Radio Access (UTRA), Global System for Mobile Communications (GSM), Code Division Multiple Access 1× Radio Transmission Technology (1×), General Packet Radio Service (GPRS), Personal Communications Service (PCS), etc.), a wireless network transceiver (e.g., 802.11X, ZigBee, Bluetooth, Wi-Fi, etc.), a combination thereof (e.g., both a cellular transceiver and a Bluetooth transceiver), and/or the like. In some arrangements, the network interface 106 includes additional devices for communicating via the network 102 using wired protocols. Further, the network interface 106 includes cryptography capabilities to establish a secure or relatively secure communication session with the financial computing system 142 or another device of the user's choosing. In this regard, data is encrypted to prevent or substantially prevent the threat of hacking.

The input/output logic 105 is configured to receive user input from and provide information to the user 101. In this regard, the input/output logic 105 is structured to exchange data, communications, instructions, etc. with an input/output component of the device 110. Accordingly, in some arrangements, the input/output logic 105 includes an input/output device such as a display device, touchscreen, keyboard, microphone, and/or the like. In some arrangements, the input/output logic 105 includes communication circuitry for facilitating the exchange of data, values, messages, and the like between the input/output device and the components of the user device 110 (e.g., the reward vesting circuit 165). In some arrangements, the input/output logic 105 includes machine-readable media for facilitating the exchange of information between the input/output device and the components of the user device 110 (e.g., the reward vesting circuit 16). In still another arrangement, the input/output logic 105 includes any combination of hardware components (e.g., a touchscreen), communication circuitry, and machine-readable media.

The user device 110 includes a reward vesting circuit 165, banking client application 170, and a mobile wallet client application 180. One or more of the reward vesting circuit 165, banking client application 170, or mobile wallet client application 180 are server-based applications executable on the user device 110. In this regard, a user has to first download the application(s) prior to usage. In another arrangement, the reward vesting circuit 165, banking client application 170, and/or mobile wallet client application 180 are hard coded into the memory of the user device 110. In still another arrangement, the reward vesting circuit 165, banking client application 170, and/or mobile wallet client application 180 are web-based interface applications. In this configuration, the user 101 has to log onto or access the web-based interface before usage. In this regard, at least one of the reward vesting circuit 165, banking client application 170, and mobile wallet client application 180 is supported by a separate computing system comprising one or more servers, processors, network interface modules, etc. that transmit the applications for use to the user device 110. In certain arrangements, one or more of the reward vesting circuit 165, banking client application 170, and/or mobile wallet client application 180 include an Application Programming Interface (API) and/or a Software Development Kit (SDK) that facilitate integration of other applications with the one or more of the reward vesting circuit 165, banking client application 170, or mobile wallet client application 180. All such variations and combinations are intended to fall within the spirit and scope of the present disclosure.

The banking client application 170 is communicably coupled to the financial computing system 142 (e.g., the accounts database 152) via the network 102 and is structured to permit management of at least one account of the user 101 via the banking client application 170. In this regard, the banking client application 170 provides displays indicative of account information such as, but not limited to, current account balances, pending transactions, profile information (e.g., contact information), reward associated with the account, bill pay information and/or the like. Further, in some arrangements, the banking client application 170 is configured to process payments from the user 101 to a designated recipient. For example, the banking client application 170 depicts a loan (e.g., mortgage) of the user 101 and allow the user 101 to pay the mortgage from an account (e.g., checking or savings). In some examples, a bill pay option is provided by the banking client application 170, where the bill pay option allows the user 101 to pay his/her bills in response to user input.

As mentioned herein, via the banking client application 170, the user 101 pays bills (e.g., mortgage, etc.), view balances, and otherwise manage their account. Accordingly and as shown, the mobile bank client application 170 includes an account information circuit 114. The account information circuit 114 is linked or otherwise coupled to one or more accounts held by the user 101 and permit management of the associated accounts (e.g., transfer balances between accounts, see payment history, etc.). The banking client application 170 is also communicably coupled to the mobile wallet client application 180. As such, in response to a mobile payment via the application 180, the application 180 causes the banking client application 170 to update the payment account (i.e., the account that supported the mobile payment). As such, the mobile wallet and banking client applications 180 and 170 are communicably coupled to each other to enable actions supported by each respective application.

The mobile wallet client application 180 is communicably coupled to the financial institution computing system 142 (e.g., the mobile wallets database 152) via the network 102 and is structured to facilitate purchases by the user 101 via the mobile wallet client application 180. Accordingly, the mobile wallet client application 180 is linked or otherwise connected with one or more accounts of the user 101. In operation, when at a point-of-sale terminal, the user 101 initiates the mobile wallet client application 180 and provides a passcode (e.g., biometrics such as a thumbprint, a Personal Identification Number (PIN), a password, etc.) to authenticate the user 101 and select the source payment account desired (e.g., a checking account from a particular financial institution that is linked to the mobile wallet client application 180). Via communication with the payment terminal (e.g., via near field communication), the aforementioned payment information is provided and the payment processed. Beneficially, carrying payment cards are avoided or reduced via the mobile wallet client application 180.

As mentioned herein, the mobile wallet client application 180 is structured to facilitate and permit payments by interfacing with an account (e.g., a checking account) held by the user 101 at the financial institution 140. Accordingly, the mobile wallet client application 180 is communicably coupled via the network interface 106 over the network 102 to the financial institution computing system 142. As shown, the mobile wallet client application 180 includes a payment processing circuit 116 structured to facilitate payments by the user 101 via the mobile wallet client application 180. For example, the payment processing circuit 116 enables a quick-pay capability with a merchant. In this regard, the payment processing circuit 116 includes or be communicably coupled with a communication device (e.g., a near-field communication chip) that facilitates the exchange of information between the mobile wallet client application 180 and a point-of-sale terminal.

The reward vesting circuit 165 is communicably coupled to the financial institution computing system 142 (e.g., the reward vesting circuit 160) via the network 102 and is structured to facilitate operations of the reward vesting circuit 160. In some arrangements, the reward vesting circuit 165 obtains user input via the input/output logic 105 related to a reward of the user 101.

For example, in response to receiving user input corresponding to a reward parameter, the reward vesting circuit 165 determines the reward parameter based on the user input and configure the network interface 106 to send the reward parameter via the network 102 to the financial institution computing system 142 (e.g., the reward vesting circuit 160) for determining the reward in the manner described herein. In another example, in response to receiving user input corresponding to a trigger event, the reward vesting circuit 165 determines a trigger message corresponding to the trigger event based on the user input and configure the network interface 106 to send the trigger message via the network 102 to the financial institution computing system 142 (e.g., the reward vesting circuit 160) for triggering vesting of a portion of the reward.

In yet another example, in response to receiving user input for collecting a vested and uncollected portion of the reward, the reward vesting circuit 165 determines a collection user request based on the user input and configure the network interface 106 to send the collection user request via the network 102 to the financial institution computing system 142 (e.g., the reward vesting circuit 160) for collecting the vested and uncollected portion. In yet another example, in response to receiving user input for monitoring various aspects of the reward, the reward vesting circuit 165 determines a monitor request and configure the network interface 106 to send the monitor request via the network 102 to the financial institution computing system 142 (e.g., the reward vesting circuit 160) for obtaining information related to the reward, as requested by the user 101.

In yet another example, in response to receiving user input corresponding to a time-modifying parameter, the reward vesting circuit 165 determines the time-modifying parameter based on the user input and configure the network interface 106 to send the time-modifying parameter via the network 102 to the financial institution computing system 142 (e.g., the reward vesting circuit 160). In yet another example, in response to receiving user input corresponding to an amount-modifying parameter, the reward vesting circuit 165 determines the amount-modifying parameter based on the user input and configure the network interface 106 to send the amount-modifying parameter via the network 102 to the financial institution computing system 142 (e.g., the reward vesting circuit 160).

In some arrangements, the user input obtained by the reward vesting circuit 165 is consumed by one or more of the banking client application 170 or mobile wallet client application 180. In other words, user input designated for using financial products or services offered by the banking client application 170 or mobile wallet client application 180 is used for various aspects of the reward vesting arrangements in the manner described. Illustrating with a non-limiting example, a user input corresponding to opening an account on the banking client application 170 is used to determine a corresponding reward parameter, which is sent via the network 102 to the financial institution computing system 142 for determining the reward. Illustrating with another non-limiting example, a user input (e.g., adding biometric security data by scanning a thumb of the user 101) corresponding to improving security of thee banking client application 170 or mobile wallet client application 180 corresponds to a trigger event that can trigger vesting of a portion of the reward.

In alternative arrangements, the reward vesting circuit 165 performs one or more functions described with respect to the reward vesting circuit 160 of the financial institution computing system 142. In such arrangements, instead of sending various parameters such as, but not limited to, reward parameter, trigger message, collection user request, monitor request, time-modifying parameter, amount-modifying parameter, and/or the like to the reward vesting circuit 160, the reward vesting circuit 165 consumes such parameters locally at the user device 110 to perform functions described with respect to the reward vesting circuit 160.

In some arrangement, a reward refers to reward points, cash back, or redemption earned by the user 101 in the course of dealing with the financial institution. The reward is earned through various activities of the user 101 including, but not limited to, creating or otherwise opening an account (checking, saving, credit, investment, retirement, and/or the like), depositing funds, borrowing, improving security of an account, financing, retiring, investing, spending, creating a financial plan, a combination thereof, and/or the like.

Referring now to FIG. 2, the functions and structures of the reward vesting circuit 160 of the financial institution computing system 142 are shown in greater detail according to some arrangements. Referring to FIGS. 1-2, while the functions and structures of the reward vesting circuit 160 are described with reference to the financial institution computing system 142, one of ordinary skill in the art can appreciate that one or more functions or structures of the reward vesting circuit 160 are implemented with the reward vesting circuit 165 of the user device 110 in alternative arrangements.

In some arrangements, the reward vesting circuit 160 includes one or more of a reward determination circuit 210, vesting schedule circuit 220, trigger detection circuit 230, modification circuit 240, collection circuit 250, or reward database 260. In some examples, one or more of the reward determination circuit 210, vesting schedule circuit 220, trigger detection circuit 230, modification circuit 240, collection circuit 250 are implemented within the processor 144. For example, one or more of the reward determination circuit 210, vesting schedule circuit 220, trigger detection circuit 230, modification circuit 240, collection circuit 250 are implemented as a software application stored within the memory 146 and executed by the processor 144. In some examples, the reward database 260 is a suitable storage or database included in the memory 146. Accordingly, such examples can be implemented with minimal additional hardware costs. However, other examples relate to implementing one or more of the reward determination circuit 210, vesting schedule circuit 220, trigger detection circuit 230, modification circuit 240, collection circuit 250 with dedicated hardware specifically configured for performing operations described herein with respect to each component. For example, one or more of the reward determination circuit 210, vesting schedule circuit 220, trigger detection circuit 230, modification circuit 240, collection circuit 250 are implemented as a separate processing component (i.e., separate from the processor 144 and/or the memory 146).

The reward determination circuit 210 is configured to determine the reward (e.g., the amount of the reward). In some arrangements, the reward determination circuit 210 determines the reward based on the reward parameter received from the user device 110. In alternative arrangements, the reward parameter is communicated locally at the financial institution computing system 142. Illustrating with a non-limiting example, the reward parameter is determined automatically based on changes to one or more aspects of the account of the user 101 in the account database 150 or mobile wallet database 152. Illustrating with another non-limiting example, the reward parameter is received from an input/output logic (not shown) of the financial institution computing system 142. For instance, a designated personnel having access to the financial institution computing system 142 inputs the reward parameter via the input/output logic of the financial institution computing system 142.

The reward parameter is determined in response to the user 101 performing one or more of actions such as, but not limited to, creating or otherwise opening an account (checking, saving, credit, investment, retirement, and/or the like), depositing funds, borrowing, improving security of an account, financing, retiring, investing, spending, creating a financial plan, a combination thereof, and/or the like. In some arrangements, in response to determining user input corresponding to such actions (e.g., with respect to the banking client application 170 and/or the mobile wallet client application 180), a corresponding reward parameter is determined. The reward parameter varies based on the type of action associated with the reward parameter. Illustrating with a non-limiting example, opening a saving account is associated with a first reward parameter corresponding to a first amount of points as the reward while creating a financial plan is associated with a second reward parameter corresponding to a second amount of points as the reward.

In some arrangements, the vesting schedule circuit 220 determines a vesting schedule for vesting portions of the reward in the manner described. One or more portions of the reward vests based on the vesting schedule. In some arrangements, the vesting schedule includes, but not limited to, a vesting period, number of portions into which the reward is partitioned into, vesting time for at least one portion, an amount for at least one portion, a combination thereof, and/or the like. In some arrangements, the vesting schedule is altered based on one or more of a time-modifying parameter or amount-modifying parameter.

In some arrangements, the trigger detection circuit 230 detects a trigger event in response to which a portion of the reward vests. In other words, a vesting time of a portion of the reward is determined in response to detecting the trigger event. For example, the trigger detection circuit 230 receives a trigger message via the network 102 from the user device 110. The trigger message indicates one or more trigger events in the manner described. In some examples, the trigger detection circuit 230 detects a trigger event in response to receiving user input from an input/output logic (not shown) of the financial institution computing system 142. For instance, a designated personnel having access to the financial institution computing system 142 inputs a trigger message via the input/output logic of the financial institution computing system 142. In some arrangements, the trigger detection circuit 230 detects the trigger events in response to determining changes to one or more accounts associated with the user 101 at the account database 150 and/or mobile wallet database 152 that correspond to one or more of the trigger event described herein.

In some arrangements, the modification circuit 240 is configured to modify at least one of a length of the vesting period or vesting time at which a portion of the reward vests in the vesting period in the manner described. In some arrangements, the modification circuit 240 is configured to modify at least one of an amount for an unvested remainder of the reward or a portion of the reward yet to vest in the manner described.

In some arrangements, the collection circuit 250 allows a portion of the reward to vest or otherwise become collectable by the user 101 in the manner described. For example, the collection circuit 250 adds a vested and collected portion to at least one account associated with the user 101 in the manner described.

In some arrangements, the reward database 260 stores information related to the reward associated with the user 101. The information includes, but not limited to, an amount of the reward, vesting schedule indicating at least one vesting time and amount of at least one portion of the reward to be vested, vested amount of the reward, unvested remainder of the reward, an option to accelerate the at least one vesting time of the at least one portion of the reward to be vested, or an option to increase the unvested remainder of the reward.

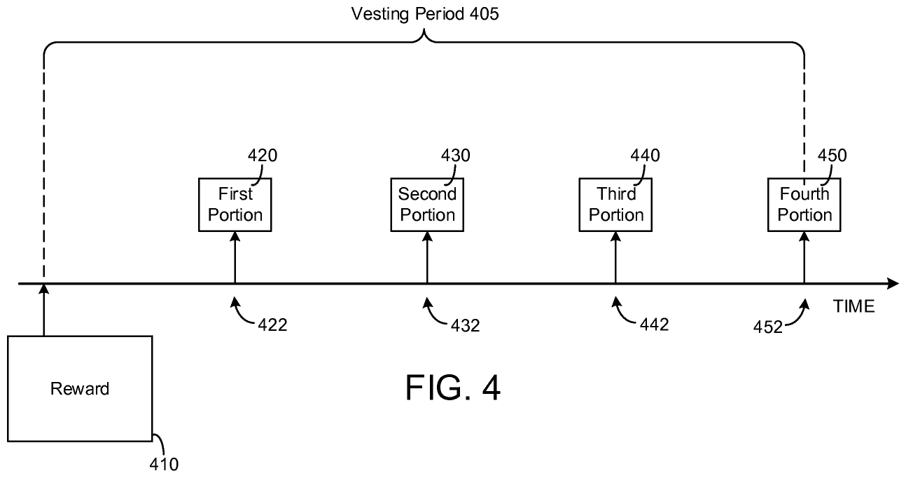

FIG. 3 is a flow diagram illustrating an example of a reward vesting management method 300 according to various arrangements. The reward vesting management method 300 is a method for vesting a reward (e.g., credit card reward points) over a vesting period. FIG. 4 is a diagram illustrating an example of the reward vesting management method 300 (FIG. 3) in some arrangements. Referring to FIGS. 1-4, the reward vesting management method 300 is performed by the reward vesting circuit 160 of the financial institution computing system 142 in some arrangements. In some arrangements, the reward vesting management method 300 can be likewise performed by the reward vesting circuit 165 of the user device 110 in alternative arrangements.

At block 310, the reward vesting circuit 160 (e.g., the reward determination circuit 210) receives at least one reward parameter. The at least one reward parameter is received from the user device 110 (e.g., via the reward vesting circuit 165) via the network 102 or locally at the financial institution computing system 142 in the manner described.

At block 320, the reward vesting circuit 160 (e.g., the reward determination circuit 210) determines a reward 410 based on the at least one reward parameter. Given that different reward parameters are associated with different actions or behaviors of the user 101, different rewards are determined. The reward parameter is determined in response to the user 101 performing one or more of actions such as, but not limited to, creating or otherwise opening an account (checking, saving, credit, investment, retirement, and/or the like), depositing funds, borrowing, improving security of an account, financing, retiring, investing, spending, creating a financial plan, a combination thereof, and/or the like. In some arrangements, in response to determining user input corresponding to such actions (e.g., with respect to the banking client application 170 and/or the mobile wallet client application 180), a corresponding reward parameter is determined. The reward parameter varies based on the type of action associated with the reward parameter. Illustrating with a non-limiting example, opening a saving account is associated with a first reward parameter corresponding to a first amount of points as the reward while creating a financial plan is associated with a second reward parameter corresponding to a second amount of points as the reward.

At block 330, the reward vesting circuit 160 allows the reward 410 to vest over a vesting period 405. Illustrating with the non-limiting example presented in FIG. 4, the reward 410 is partitioned into 4 portions, including a first portion 420, second portion 430, third portion 440, and fourth portion 450. Each portion 420, 430, 440, or 450 vests at an associated vesting time 422, 432, 442, or 452, respectively, within the vesting period 405. When a portion 420, 430, 440, or 450 vests, the user 101 collects the vested and uncollected portion 420, 430, 440, or 450. Before the portion 420, 430, 440, or 450 vests, the user 101 is not be able to collect the unvested portion of the reward 410.

Illustrating with the non-limiting example, the first vesting time 422 is determined within the vesting period 405, such that the first portion 420 associated with the first vesting time 422 vests at the first vesting time 422. The second vesting time 432 is determined within the vesting period 405, such that the second portion 430 associated with the second vesting time 432 vests at the second vesting time 432. The second vesting time 432 is later in time as compared to the first vesting time 422. Both the first vesting time 422 and second vesting time 432 is later in time as compared to the time at which the reward 410 is determined or otherwise earned. In other arrangements, a portion of the reward 410 vests at the time at which the reward 410 is determined or otherwise earned.

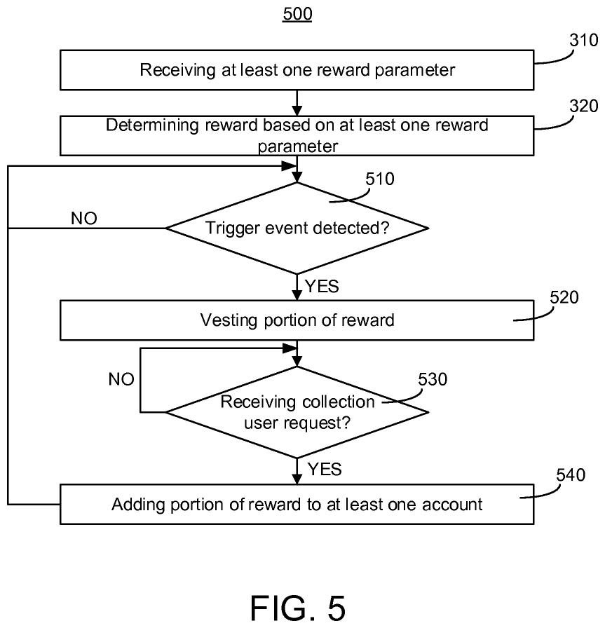

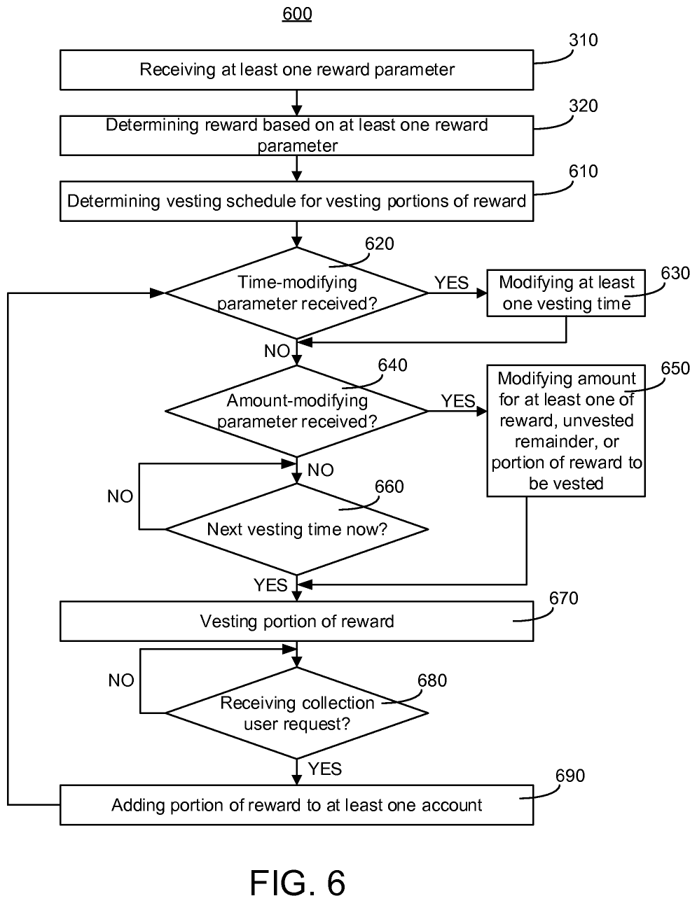

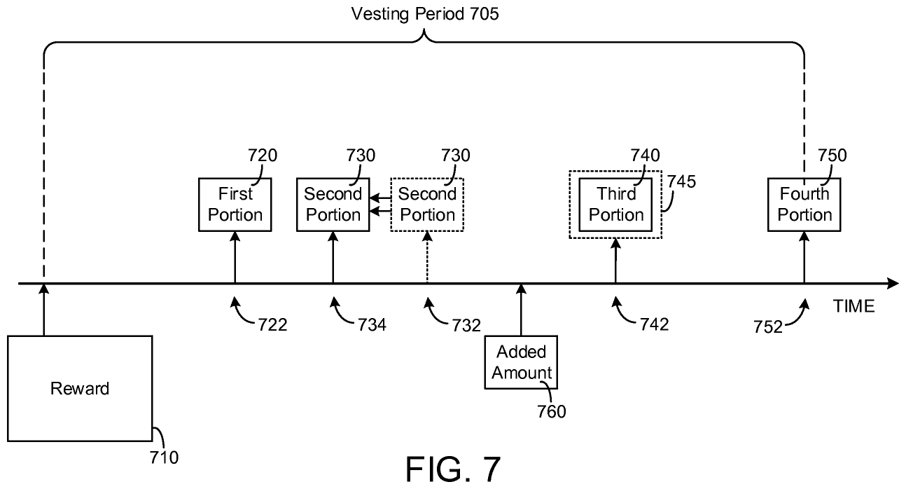

In some arrangements, one or more of the portions 420, 430, 440, or 450 vest based on trigger events in the manner described with respect to FIG. 5. In some arrangements, one or more of the portions 420, 430, 440, or 450 vest based on a vesting schedule in the manner described with respect to FIGS. 6 and 7.

FIG. 5 is a flow diagram illustrating an example of a reward vesting management method 500 featuring vesting by trigger events according to various arrangements. Referring to FIGS. 1-5, the reward vesting management method 500 is a particular implementation of the method 300 involving triggers for vesting a portion of the reward. For example, blocks 510-540 represent one aspect of block 330 in some arrangements. The reward vesting management method 500 is performed by the reward vesting circuit 160 of the financial institution computing system 142 in some arrangements. In some arrangements, the reward vesting management method 500 can likewise be performed by the reward vesting circuit 165 of the user device 110 in alternative arrangements.

At block 510, the trigger detection circuit 230 determines whether at least one trigger event has been detected. A trigger event corresponds to an action or behavior of the user 101 such as, but not limited to, creating or otherwise opening an account (checking, saving, credit, investment, retirement, and/or the like), depositing funds, borrowing, improving security of an account, financing, retiring, investing, spending, creating a financial plan, a combination thereof, and/or the like. For example, in response to receiving user input via the input/output logic 105 concerning one or more of the actions/behaviors directed to the banking client application 170 or mobile wallet client application 180, the reward vesting circuit 165 of the user device 110 configures the network interface 106 to send a trigger message to the financial institution computing system 142 (e.g., the reward vesting circuit 160) via the network 102. The trigger detection circuit 230 detects the trigger event in response to receiving the trigger message corresponding to the trigger event.

At block 520, the collection circuit 250 allows a portion of the reward to vest. In some arrangements, a portion having a predetermined amount vests in response to the trigger event. The predetermined amount is a predetermined amount of points, cash back, or redemption in some examples. In other examples, the predetermined amount is a percentage of the reward or a percentage of an unvested remainder of the reward. In some arrangements, the amount of the portion vested in response to the trigger event is determined (e.g., by the trigger detection circuit 230) based on the type of trigger event detected. For instance, given that different trigger events are associated with different actions or behaviors of the user 101, different amount of a portion is determined based on the types trigger events. Illustrating with a non-limiting example, depositing funds above a threshold is associated with a first amount to be vested, while the user 101 retiring form a job is associated with a second different amount to be vested. In other examples, each portion has the same amount.

At block 530, the collection circuit 250 determines whether a collection user request is received from the user device 110. For example, in response to receiving user input at the input/output logic 105 for collecting the vested and uncollected portion (e.g., vested at block 520), the reward vesting circuit 165 of the user device 110 determines a collection user request based on the user input and configure the network interface 106 to send the collection user request via the network 102 to the financial institution computing system 142 (e.g., the collection circuit 250).

In response to determining that no collection user request has been received (530:NO), the method 500 continues at block 530. On the other hand, in response to determining that a collection user request has been received (530:YES), the collection circuit 250 adds the vested and collected portion to at least one account associated with the user 101. Illustrating with a non-limiting example, the vested and collected portion (e.g., points) is added to a reward account associated with the user 101 and managed by the reward database 260. The user 101, via the input/output logic of the user device 110, purchases with the vested and collected portion. Illustrating with a non-limiting example, the vested and collected portion (e.g., points) is added to one or more accounts associated with the user 101 and managed by the account database 150 and/or mobile wallet database 152, as cashback.

FIG. 6 is a flow diagram illustrating an example of a reward vesting management method 600 featuring vesting by a vesting schedule according to various arrangements. FIG. 7 is a diagram illustrating an example of the reward vesting management method 600 involving modifications to the amount of vesting time of various aspects of the reward in some arrangements. Referring to FIGS. 1-7, the reward vesting management method 600 is a particular implementation of the method 300. For example, blocks 610-690 represent one aspect of block 330 in some arrangements. The reward vesting management method 600 is performed by the reward vesting circuit 160 of the financial institution computing system 142 in some arrangements. In some arrangements, the reward vesting management method 600 can be likewise performed by the reward vesting circuit 165 of the user device 110 in alternative arrangements.

At block 610, the reward vesting circuit 160 (e.g., the vesting schedule circuit 220) determines a vesting schedule for vesting portions (e.g., portions 720, 730, 740, and 750) of a reward 710. In some arrangements, the vesting schedule includes, but not limited to, a vesting period 705, number of portions into which the reward 710 is partitioned into, vesting time for at least one portion 720, 730, 740, or 750, an amount for at least one portion 720, 730, 740, or 750, a combination thereof, and/or the like.

In some arrangements, the vesting period 705 is determined by the vesting schedule circuit 220 based on the reward parameter received at block 310. For instance, given that different reward parameters are associated with different actions or behaviors of the user 101, different vesting periods are determined based on the reward parameters. Illustrating with a non-limiting example, opening a saving account is associated with a first vesting period while creating a financial plan is associated with a second vesting period having a different length as compared to that of the first vesting period. Other parameters indicative of actions or behaviors of the user 101 serve as a basis for determining the length of the vesting period 705. In other arrangements, the vesting period is the same for two or more different reward parameters.

In some arrangements, a number of portions (e.g., the portions 720, 730, 740, and 750) into which the reward 710 is partitioned into, vesting time (e.g., vesting time 722, 732, 742, or 752) for at least one portion 720, 730, 740, or 750, and/or amount for at least one portion 720, 730, 740, or 750 are determined by the vesting schedule circuit 220 based on any suitable criteria such as, but not limited to, the reward parameter received at block 310. For instance, given that different reward parameters are associated with different actions or behaviors of the user 101, the number of portions 720, 730, 740, and 750 into which the reward 710 is partitioned into, vesting times 722, 732, 742, and 752, and/or amount for the portions 720, 730, 740, and 750 are determined by the vesting schedule circuit 220 based on the reward parameter.

Illustrating with a non-limiting example, a reward parameter corresponding to opening a saving account is associated with a first number of portions while another reward parameter corresponding to creating a financial plan is associated with a second number of portions. Illustrating with another non-limiting example, a reward parameter corresponding opening a checking account is associated with annual vesting times (e.g., time interval between two consecutive vesting times is a year) while creating a financial plan is associated with monthly vesting times. Illustrating with yet another non-limiting example, a reward parameter corresponding opening an investment account is associated with a first amount of each of the partitioned portions while creating a financial plan is associated with a second amount of each of the partitioned portions.

In some arrangements, the vesting times are periodic (e.g., annually, semi-annually, quarterly, monthly, weekly, daily, or the like). In other arrangements, the vesting times are scheduled in other suitable scheme such as, but not limited to, a progressively accelerated scheme, progressively decelerated scheme, arbitrary scheme, or the like.

In the non-limiting example shown in FIG. 7, the reward 710 is partitioned into 4 equal portions 720, 730, 740, and 750. The vesting times 722, 732, 742, and 752 are set annually. For example, whereas the reward 710 is earned on Jan. 1, 2016, the first portion 720 vests on Jan. 1, 2017 (first vesting time 722). The second portion 730 vests on Jan. 1, 2018 (second vesting time 732). The third portion 740 vests on Jan. 1, 2019 (third vesting time 742). The fourth portion 750 vests on Jan. 1, 2020 (fourth vesting time 752).

At block 620, the reward vesting circuit 160 (e.g., the modification circuit 240) determines whether a time-modifying parameter has been received. The time-modifying parameter corresponds to one or more of actions or behaviors of the user 101 such as, but not limited to, opening an account (checking, saving, credit, investment, retirement, and/or the like), depositing funds, borrowing, improving security of an account, financing, retiring, investing, spending, creating a financial plan, a combination thereof, and/or the like.

For example, in response to receiving user input via the input/output logic 105 concerning one or more of the actions/behaviors directed to the banking client application 170 or mobile wallet client application 180, the reward vesting circuit 165 of the user device 110 configures the network interface 106 to send a time-modifying parameter to the financial institution computing system 142 (e.g., the reward vesting circuit 160) via the network 102. The modification circuit 240 accordingly receives the time-modifying parameter. In alternative arrangements, the time-modifying parameter is communicated locally at the financial institution computing system 142. Illustrating with a non-limiting example, the time-modifying parameter is determined automatically based on changes to one or more aspects of the account of the user 101 in the account database 150 or mobile wallet database 152. Illustrating with another non-limiting example, the time-modifying parameter is received from an input/output logic (not shown) of the financial institution computing system 142. For instance, a designated personnel having access to the financial institution computing system 142 inputs the time-modifying parameter via the input/output logic (such as, but not limited to, the input/output logic 105) of the financial institution computing system 142.

In response to determining that the time-modifying parameter has not been received (620:NO), the method 600 proceeds to block 640. On the other hand, in response to determining that the time-modifying parameter has been received (620:YES), the modification circuit 240 modifies at least one vesting time. Illustrating with a non-limiting example, in response to receiving a time-modifying parameter corresponding to an accelerated payout of the second portion 730, the modification circuit 240 modifies the second vesting time 732 corresponding to the second portion 730 to a modified second vesting time 734. Given that the time-modifying parameter indicates an accelerated payout with respect to the second portion 730, the modified second vesting time 734 is earlier in time than the second vesting time 732. In some arrangements, the length of the vest period 705 is modified (e.g., lengthened or shortened) based on the time-modifying parameter.

In some arrangements, the modified vest time (e.g., the modified second vesting time 734) is determined based on a predetermined offset. Illustrating with a non-limiting example, the modified second vesting time 734 (e.g., Jul. 1, 2017) is approximately half a period (e.g., half a year) earlier than the second vesting time 732 (e.g., Jan. 1, 2018). In other arrangements, the offset is determined based on the time-modifying parameter. For instance, given that different time-modifying parameters are associated with different actions or behaviors of the user 101, the time offset caries based on the time-modifying parameter. Illustrating with a non-limiting example, a time-modifying parameter corresponding to the user 101 signing up for an “AutoPay” option in banking accelerates the vesting time by a first amount. On the other hand, a time-modifying parameter corresponding to the user 101 failing to pay a due debt on time delays the vesting time by a second amount.

At block 640, the modification circuit 240 determines whether an amount-modifying parameter has been received. The amount-modifying parameter corresponds to one or more of actions or behaviors of the user 101 such as, but not limited to, opening an account (checking, saving, credit, investment, retirement, and/or the like), depositing funds, borrowing, improving security of an account, financing, retiring, investing, spending, creating a financial plan, a combination thereof, and/or the like. In some arrangements, the amount-modifying parameter is the same as the time-modifying parameter. In other examples, the amount-modifying parameter is different from the time-modifying parameter.

For example, in response to receiving user input via the input/output logic 105 concerning one or more of the actions/behaviors directed to the banking client application 170 or mobile wallet client application 180, the reward vesting circuit 165 of the user device 110 configures the network interface 106 to send an amount-modifying parameter to the financial institution computing system 142 (e.g., the reward vesting circuit 160) via the network 102. The modification circuit 240 accordingly receives the amount-modifying parameter. In alternative arrangements, the amount-modifying parameter is communicated locally at the financial institution computing system 142. Illustrating with a non-limiting example, the amount-modifying parameter is determined automatically based on changes to one or more aspects of the account of the user 101 in the account database 150 or mobile wallet database 152. Illustrating with another non-limiting example, the amount-modifying parameter is received from an input/output logic (not shown) of the financial institution computing system 142. For instance, a designated personnel having access to the financial institution computing system 142 inputs the amount-modifying parameter via the input/output logic of the financial institution computing system 142.

In response to determining that the amount-modifying parameter has not been received (640:NO), the method 600 proceeds to block 660. On the other hand, in response to determining that the amount-modifying parameter has been received (640:YES), the modification circuit 240 modifies the amount for at least one portion 720, 730, 740, or 750. Illustrating with a non-limiting example, in response to receiving an amount-modifying parameter corresponding to increasing the amount of the third portion 740, the modification circuit 240 increases the third portion 740 to a modified third portion 745. Given that the amount-modifying parameter indicates an increase with respect to the amount of the third portion 740, the modified third portion 745 is more than the third portion 740.

The unvested remainder of the reward 710 is modified (increased or decreased) in a similar manner in response to receiving the amount-modifying parameter. Illustrating with another non-limiting example, in response to receiving an amount-modifying parameter corresponding to increasing the amount of the unvested remainder of the reward 710, the modification circuit 240 increases the unvested remainder by an added amount 760. Assuming that the reward 710 includes 100,000 points partitioned evenly into the portions 720, 730, 740, and 750 with 25,000 points each, the unvested remainder is 50,000 points before the added amount 760 has been added. After the added amount 760 (e.g., 20,000 points) has been added, the unvested remainder becomes 70,000 points. In some arrangements, in response to the unvested remainder being modified, an amount of the unvested portion (e.g., the portions 740, 745, and/or 750) is adjusted (e.g., increased or decreased) accordingly. In some arrangements, in response to the unvested remainder being modified, one or more portions additional to the portions 720, 730, 740, and 750 are determined to vest at some point within the vesting period 705. The length of the vesting period 705 is modified based on modifications to the unvested remainder.

In some arrangements, the modified amount of a portion (e.g., the modified third portion 745) is determined based on a predetermined offset. Illustrating with a non-limiting example, the modified third portion 745 is twice the amount of the third portion 740. In other arrangements, the offset is determined based on the amount-modifying parameter. For instance, given that different amount-modifying parameters are associated with different actions or behaviors of the user 101, the amount offset caries based on the amount-modifying parameter. Illustrating with a non-limiting example, an amount-modifying parameter corresponding to the user 101 signing up for an additional financial services offering increases the amount of a portion by a first modified amount. On the other hand, another amount-modifying parameter corresponding to the user 101 failing to pay a debt on time decreases the amount of a portion by a second modified amount.

At block 660, the vesting schedule circuit 220 determines whether a next vesting time (e.g., vesting times 722, 734, 742, 752) is now. In response to determining that the next vesting time is not now (660:NO), the method 600 returns to block 660. On the other hand, in response to determining that the next vesting time is now (660:YES), the collection circuit 250 allows a portion of the reward corresponding to the next vesting time to vest at block 670. In some examples, in response to determining that the next vesting time is now (660:YES), the collection circuit 250 configures the network interface 148 to send an indication message indicating that the portion of the reward has vested. In response to receiving the indication message, the reward vesting circuit 165 configures the input/output logic 105 to display a notification corresponding to the indication message to the user 101, notifying the user 101 that the portion of the reward has vested.

At block 680, the collection circuit 250 determines whether a collection user request is received from the user device 110. For example, in response to receiving user input at the input/output logic 105 for collecting the vested and uncollected portion, the reward vesting circuit 165 of the user device 110 determines a collection user request based on the user input and configure the network interface 106 to send the collection user request via the network 102 to the financial institution computing system 142 (e.g., the collection circuit 250).

In response to determining that no collection user request has been received (680:NO), the method 500 continues at block 680. On the other hand, in response to determining that a collection user request has been received (680:YES), the collection circuit 250 increases the vested and collected portion to at least one account associated with the user 101 in the manner described.

While blocks 610-690 are presented in FIG. 6 in a sequential manner, the blocks can be executed in any suitable order, or simultaneously.

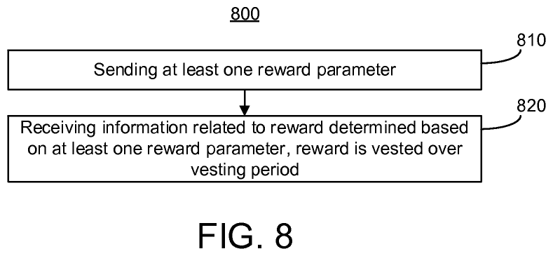

FIG. 8 is a flow diagram illustrating an example of a reward vesting management method 800 performed by the user device 110 for initiating determination of the reward and vesting of the reward over a vesting period according to various arrangements. Referring to FIGS. 1-8, the reward vesting management method 800 is performed by the reward vesting circuit 165 of the user device 110 in some arrangements.

At block 810, the reward vesting circuit 165 sends at least one reward parameter via the network 102 to the financial institution computing system 142. At block 820, the reward vesting circuit 165 receives via the network 102 information related to the reward determined based on the at least one parameter sent at block 810. The reward vests over a vesting period. The information includes, but not limited to, an amount of the reward, vesting schedule indicating at least one vesting time and amount of at least one portion of the reward to be vested, vested amount of the reward, unvested remainder of the reward, an option to accelerate the at least one vesting time of the at least one portion of the reward to be vested, or an option to increase the unvested remainder of the reward.

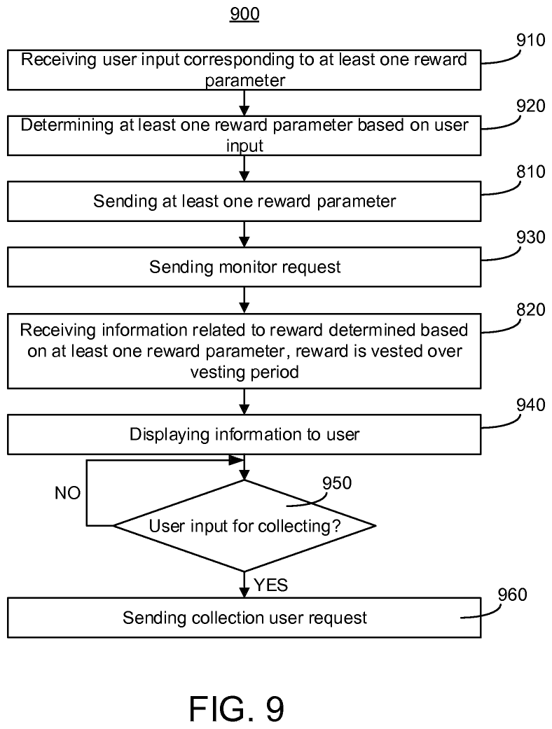

In some arrangements, the information is received from the financial institution computing system 142 automatically at predefined times. For instance, the information is received form the financial institution computing system 142 periodically (e.g., annually, semi-annually, quarterly, monthly, weekly, daily, or the like). In some arrangements, the information is received from the financial institution computing system 142 corresponding to a monitor request sent by the user device 110 in the manner described in more detail with respect to FIG. 9.

FIG. 9 is a flow diagram illustrating an example of a reward vesting management method 900 performed by the user device 110 according to various arrangements. Referring to FIGS. 1-9, the reward vesting management method 900 is a particular arrangement of the reward vesting management method 800. The reward vesting management method 900 is performed by the reward vesting circuit 165 of the user device 110 in some arrangements.

At block 910, the reward vesting circuit 165 receives the user input corresponding to the at least one reward parameter, for example, via the input/output logic 105 in the manner described herein. At block 920, the reward vesting circuit 165 determines the at least one reward parameter based on the user input in the manner described herein. At block 810, the reward vesting circuit 165 configures the network interface 106 to send the at least one reward parameter via the network 102 to the financial institution computing system 142.

At block 930, the reward vesting circuit 165 configures the network interface 106 to send a monitor request to the financial institution computing system 142. For instance, user input from the user 101 is received via the input/output logic 105 indicating that information related to the reward is desired. Such user input is received as a part of an application executed by the reward vesting circuit 165, banking client application 170, mobile wallet client application 180, a combination thereof, and/or the like. Based on the user input, the reward vesting circuit 165 determines the monitoring request.

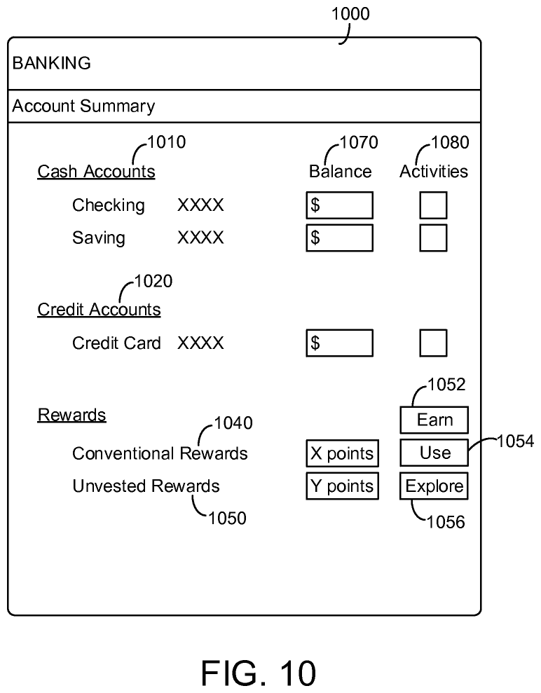

At block 820, the reward vesting circuit 165 receives information related to the reward determined based on the at least one parameter sent at block 810 from the financial institution computing system 142. At block 940, the reward vesting circuit 165 displays the information to the user in a manner described with respect to FIGS. 10-12.

At block 950, the reward vesting circuit 165 determines whether user input for collecting at least a vested and uncollected portion has been received via the input/output logic 105. In response to determining that no user input for collecting has been received (950:NO), the method 900 returns to block 950. On the other hand, in response to determining that the user input for collecting has been received from input/output logic 105 (950:YES), the reward vesting circuit 165 determines a collection user request based on the user input and configure the network interface 106 to send the collection user request via the network 102 to the financial institution 140, at block 960.

FIG. 10 is a diagram of a display user interface 1000 outputted by the input/output logic 105 of the user device 110 presenting the information related to vesting rewards. Referring to FIGS. 1-10, the display user interface 1000 is provided by a user interface aspect of one or more of the reward vesting circuit 165, banking client application 170, or mobile wallet client application 180. The display user interface 1000 is displayed at block 940.

A display user interface (e.g., the display user interface 1000) outputs the information related to the vesting rewards. For instance, the display user interface 1000 outputs an amount (e.g., “Y points”) of an unvested remainder 1050 of a vesting reward in a balance column 1070. User interactive elements “earn” 1052, “use” 1054, and “explore” 1056 are presented to the user 101 in the display user interface 1000. In response to selecting the “earn” element 1052, the input/output logic 105 displays another user interface (e.g., a new interface or a window overlaid (current display user interface 1000) in which the user 101 can select to increase the amount of the unvested remainder 1050 corresponding to the amount-modifying parameter. In response to selecting the “use” element 1054, the input/output logic 105 displays another user interface (e.g., a new interface or a window overlaid (current display user interface 1000) in which the user 101 can use or collected vested portions of the reward corresponding to the collection user request. In response to selecting the “explore” element 1056, the input/output logic 105 displays another user interface (e.g., a new interface or a window overlaid (current display user interface 1000) in which additional information related to the vesting reward is displayed.

In some arrangements, the information (e.g., the unvested remainder 1050) related to the reward is displayed in a same interface (e.g., the display user interface 1000) as additional information concerning account information related to one or more accounts of the user 101, at least one type of reward other than the vesting rewards, bill pay information, a combination thereof, and/or the like. In other words, the information related to the vesting reward is displayed or a same interface or screen as additional information outputted by the banking client application 170 and/or mobile wallet client application 180. In the non-limiting example shown in FIG. 10, the display user interface 1000 displays information concerning at least one cash account 1010, at least one credit account 1020, and at least another type of rewards (e.g., conventional rewards 1040). The balance column 1070 and activities 1080 column include user interactive elements for accessing additional information concerning the at least one cash account 1010, at least one credit account 1020, and/or the conventional rewards 1040.

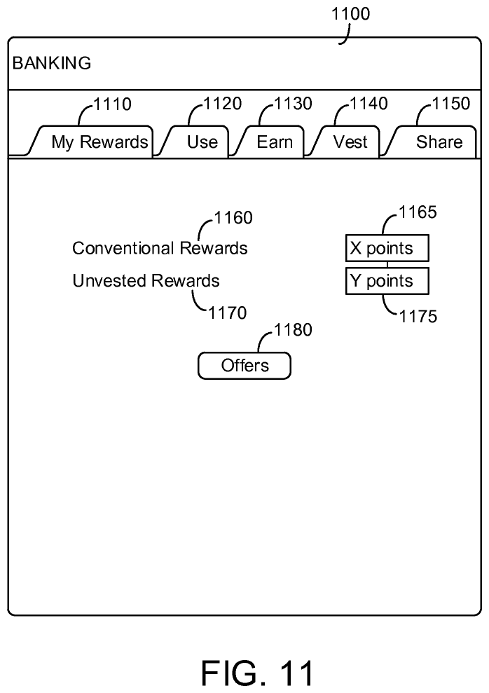

FIG. 11 is a diagram of a display user interface 1100 outputted by the input/output logic 105 of the user device 110 presenting information related to vesting rewards. Referring to FIGS. 1-11, the display user interface 1100 is provided by a user interface aspect of one or more of the reward vesting circuit 165, banking client application 170, or mobile wallet client application 180. The display user interface 1100 is displayed at block 940. In the non-limiting example shown in FIG. 11, the display user interface 1100 is displayed in response to the user 101 selecting the “explore” element 1056 on the display user interface 1000. In other examples, the display user interface 1100 is displayed in any other suitable manner.

In some arrangements, the display user interface 1100 outputs the information related to the rewards earned by the user 101 at the “my rewards” tab 1110. For instance, the display user interface 1100 outputs an amount 1175 (e.g., “Y points”) of an unvested remainder 1170 (1050) of the reward. In addition, the display user interface 1100 outputs an amount 1165 (e.g., “X points”) for conventional rewards 1160 (1040).

The display user interface 1100 includes a user interactive element “offers” 1180. The “offers” element 1180 when activated, outputs information and additional user interactive elements for obtaining financial products and/or services offered by the financial institution 140. In some arrangements, in response to the user 101 selecting the “offers” element 1180 and/or the additional user interactive elements, one or more of a trigger message, time-modifying parameter, amount-modifying parameter, reward parameter for a new vesting reward, a combination thereof, and/or the like.

User interactive elements in the form of tabs such as, but not limited to, a “use” tab 1120 (1054), “earn” tab 1130 (1052), “vest” tab 1140, and “share” tab 1150 are presented to the user 101 in the display user interface 1100. In response to selecting the “use” tab 1120, the input/output logic 105 displays another user interface in which the user 101 can use or collect vested portions of the vesting reward corresponding to the collection user request. In response to selecting the “earn” tab 1130, the input/output logic 105 displays another user interface in which the user 101 can select to increase the amount of the unvested remainder 1050 and/or a portion corresponding to the amount-modifying parameter. In response to selecting the “vest” tab 1140, the input/output logic 105 displays another user interface in which the user 101 can view additional information related to the vesting reward. In response to selecting the “share” tab 1150, the input/output logic 105 displays another user interface in which the user 101 can select to share vested or unvested portions of the reward to another user.

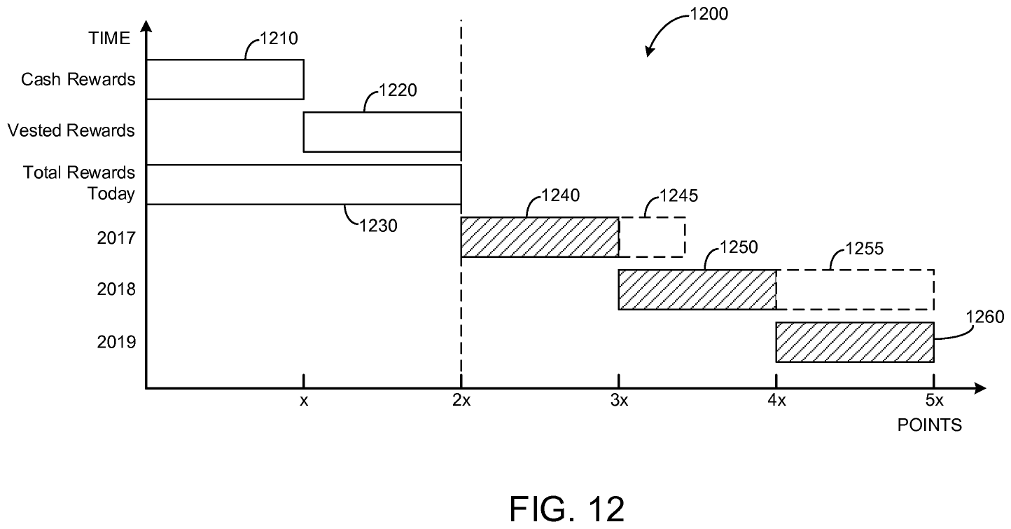

FIG. 12 is a diagram of a display user interface 1200 outputted by the input/output logic 105 of the user device 110 presenting information related to vesting rewards. Referring to FIGS. 1-12, the display user interface 1200 is provided by a user interface aspect of one or more of the reward vesting circuit 165, banking client application 170, or mobile wallet client application 180. The display user interface 1200 is displayed at block 940. In the non-limiting example shown in FIG. 12, the display user interface 1100 is displayed in response to the user 101 selecting the “vest” tab 1140 on the display user interface 1100. In other arrangements, the display user interface 1100 is displayed in any suitable manner.

The display user interface 1200 includes the vesting schedule (e.g., determined at block 610) in some arrangements. The vesting schedule is in the form of a graph (time versus points) as shown. The display user interface 1200 includes a total reward 1230 currently collectable by the user 101. The total reward 1230 includes (conventional) cash rewards 1210 and vested (and uncollected portion) reward 1220. The (conventional) cash rewards 1210 are x points. The vested (and uncollected portion) reward 1220 is x points. A total amount of vesting rewards (e.g., 4x points) earned by the user 101 is the sum of portions 1220, 1240, 1250, and 1260, each having an amount of x points. In some arrangements, one or both of the vested (and uncollected portion) reward 1220 and total reward 1230 are configured as a user interactive element such that, when selected, causes the reward vesting circuit 165 to configure the network interface 106 to send a collection user request to the financial institution computing system 142 to collect the corresponding vested portion in the manner described.

The display user interface 1200 includes a first unvested portion 1240 having a vesting time in 2017, second unvested portion 1250 having a vesting time in 2018, and third unvested portion 1260 having a vesting time in 2019. In some arrangements, the display user interface 1200 includes an amount-modifying user interactive element 1245 such that, when selected, causes the reward vesting circuit 165 to configure the network interface 106 to send an amount-modifying parameter to the financial institution computing system 142 to modify the amount of the first unvested portion 1240. In some arrangements, the display user interface 1200 includes a time-modifying user interactive element 1255 such that, when selected, causes the reward vesting circuit 165 to configure the network interface 106 to send a time-modifying parameter to the financial institution computing system 142 to modify the vesting time of the third unvested portion 1260.

The arrangements described herein have been described with reference to drawings. The drawings illustrate certain details of specific arrangements that implement the systems, methods and programs described herein. However, describing the arrangements with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some arrangements, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some arrangements, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some arrangements, the one or more processors may be embodied in various ways. The one or more processors may be constructed in a manner sufficient to perform at least the operations described herein. In some arrangements, the one or more processors may be shared by multiple circuits (e.g., circuit A and circuit B may comprise or otherwise share the same processor which, in some example arrangements, may execute instructions stored, or otherwise accessed, via different areas of memory). Alternatively or additionally, the one or more processors may be structured to perform or otherwise execute certain operations independent of one or more co-processors. In other example arrangements, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some arrangements, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the arrangements might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some arrangements, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other arrangements, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example arrangements described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative arrangements. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of arrangements has been presented for purposes of illustration and description. It is not intended to be exhaustive or to limit the disclosure to the precise form disclosed, and modifications and variations are possible in light of the above teachings or may be acquired from this disclosure. The arrangements were chosen and described in order to explain the principals of the disclosure and its practical application to enable one skilled in the art to utilize the various arrangements and with various modifications as are suited to the particular use contemplated. Other substitutions, modifications, changes and omissions may be made in the design, operating conditions and arrangement of the arrangements without departing from the scope of the present disclosure as expressed in the appended claims.

1. A method for managing rewards, the method comprising:
receiving, by a bank computing system, at least one reward parameter corresponding to an action of a user using a banking client application or a mobile wallet client application via a user interface of a user device of the user;
determining, by the bank computing system, a reward based on the at least one reward parameter, the reward differing based on a type of the action of the user in using the banking client application or the mobile wallet client application via the user interface;
receiving, by the bank computing system, a trigger event at the bank computing system, the trigger event being generated based on obtaining a biometric security user input of the user at the user interface of the user device;
modifying, by the bank computing system, the banking client application or the mobile wallet client application to receive a biometric thumbprint passcode for scanning by the banking client application or the mobile wallet client application, in response to the receiving the trigger event at the bank computing system;
generating, by the bank computing system, the reward based at least partially on the receiving the biometric security user input;
vesting, by the bank computing system, two or more portions of the reward at different times over a vesting period responsive to the trigger event;
causing, by the bank computing system, the user interface of the banking client application or the mobile wallet client application to display first user interactive elements corresponding to vested portions of the two or more portions and second user interactive elements corresponding to unvested portions of the two or more portions as a vesting schedule in a same display screen; and
receiving, by the bank computing system, a collection user request from the user device, the collection user request corresponding to the user selecting one of the first interactive elements.

2. The method of claim 1, wherein the reward comprises one or more of reward points, cash back, or redemption.

3. The method of claim 1, wherein the reward is vested periodically over the vesting period.

4. The method of claim 1, wherein
the trigger event further comprises receiving trigger messages for one or more of creating an account, depositing funds, borrowing, improving security of an account, financing, retiring, investing, spending, or creating a financial plan.

5. The method of claim 1, wherein vesting the reward over the vesting period comprises:
determining a first vesting time within the vesting period; and
vesting a first portion of the reward at the first vesting time.

6. The method of claim 5, wherein vesting the reward over the vesting period further comprises:
determining a second vesting time within the vesting period, wherein the second vesting time is after the first vesting time; and
vesting a second portion of the reward at the second vesting time.

7. The method of claim 5, wherein the first portion of the reward is refrained from vesting before the first vesting time.

8. The method of claim 1, wherein vesting the reward over the vesting period comprises allowing a vested and uncollected portion of the reward to be collected, the vested and uncollected portion of the reward corresponding to the one of the first interactive elements selected by the user.

9. The method of claim 8, further comprising:
receiving the collection user request by the bank computing system via a network from the user device, the collection user request corresponding to a vested and uncollected portion of the reward; and
adding the vested and uncollected portion of the reward to at least one account associated with the user of the user device in response to the collection user request to collect the vested and uncollected portion of the reward.

10. The method of claim 1, wherein the at least one reward parameter and the collection user request is received by the bank computing system via a network from the user device.

11. The method of claim 1, further comprising:
receiving a monitor request from the user device; and
causing the user device to display one or more of:
an amount of the reward;
the vesting schedule indicating at least one vesting time and amount of at least one portion of the reward to be vested;
a vested amount of the reward;
an unvested remainder of the reward;
an option to accelerate the at least one vesting time of the at least one portion of the reward to be vested; or
an option to increase the unvested remainder of the reward.

12. The method of claim 1, further comprising:
receiving at least one time-modifying parameter; and
modifying at least one of a length of the vesting period or vesting time at which a portion of the reward vests in the vesting period.

13. The method of claim 1, further comprising:
receiving at least one amount-modifying parameter; and
modifying amount for an unvested remainder of the reward or a portion of the reward to be vested.

14. A method for managing rewards, the method comprising:
obtaining, by a user device to a bank computing system, a biometric security user input of a user using a banking client application or a mobile wallet client application via a user interface of the user device of the user;
sending, by the user device to the bank computing system, at least one reward parameter corresponding to an action of the user, and a trigger event generated based on the obtaining the biometric security user input;
modifying, at the user device to the bank computing system, the banking client application or the mobile wallet client application to receive a biometric thumbprint passcode for scanning by the banking client application or the mobile wallet client application, in response to the sending the trigger event;
receiving, by the user device from the bank computing system, information related to a reward determined based on the at least one reward parameter and based at least partially on the obtaining the biometric security user input, the reward differing based on a type of the action of the user in using the banking client application or the mobile wallet client application via the user interface, two or more portions of the reward vesting at different times over a vesting period responsive to the trigger event;
displaying, by the user device, the user interface of the banking client application or the mobile wallet client application first user interactive elements corresponding to vested portions of the two or more portions and second user interactive elements corresponding to unvested portions of the two or more portions as a vesting schedule in a same display screen; and
sending, by the user device, a collection user request, the collection user request corresponding to the user selecting one of the first interactive elements.

15. The method of claim 14, wherein the information related to the reward comprises one or more of:
an amount of the reward;
the vesting schedule indicating at least one vesting time and amount of at least one portion of the reward to be vested;
a vested amount of the reward;
an unvested remainder of the reward;
an option to accelerate the at least one vesting time of the at least one portion of the reward to be vested; or
an option to increase the unvested remainder of the reward.

16. The method of claim 15, further comprising:
sending a monitor request to the bank computing system; and
receiving the information corresponding to the monitor request from the bank computing system.

17. The method of claim 16, further comprising displaying the information to the user of the user device.

18. The method of claim 17, wherein the information is displayed with one or more of:
account information related to one or more accounts;
at least one type of rewards other than the reward; or
bill pay information.

19. The method of claim 14, further comprising:
receiving an indication message relating to vesting a portion of the reward from the bank computing system; and
displaying a notification corresponding to the indication message to a user of the user device.

20. The method of claim 14, further comprising:
receiving a user input corresponding to collecting a vested and uncollected portion of the reward, the vested and uncollected portion of the reward corresponding to the one of the first interactive elements selected by the user.

21. The method of claim 14, further comprising receiving a user input corresponding to the at least one reward parameter.

22. A bank computing system associated with a bank, the system comprising:
a network interface structured to facilitate data communication via a network;
a memory; and
a processing circuit comprising a processor, the processing circuit configured to:
receive at least one reward parameter corresponding to an action of a user using a banking client application or a mobile wallet client application via a user interface of the user device of the user;
determine a reward based on the at least one reward parameter, the reward differing based on a type of the action of the user in using the banking client application or the mobile wallet client application via the user interface;
receiving a trigger event generated based on obtaining a biometric security user input of the user at the user interface of the user device;
modifying the banking client application or the mobile wallet client application to receive a biometric thumbprint passcode for scanning by the banking client application or the mobile wallet client application, in response to the receiving the trigger event;
generate the reward based at least partially on the receiving the biometric security user input;
vest two or more portions of the reward at different times over a vesting period responsive to the trigger event;
cause the user interface of the banking client application or the mobile wallet client application to display first user interactive elements corresponding to vested portions of the two or more portions and second user interactive elements corresponding to unvested portions of the two or more portions as a vesting schedule in a same display screen; and
receive a collection user request from the user device, the collection user request corresponding to the user selecting one of the first interactive elements.

23. The bank computing system of claim 22, wherein the reward comprises one or more of reward points, cash back, or redemption.

24. The bank computing system of claim 22, wherein the reward is vested periodically over the vesting period.

25. The bank computing system of claim 22, wherein
the trigger event further comprises receiving trigger messages for one or more of creating an account, depositing funds, borrowing, improving security of an account, financing, retiring, investing, spending, or creating a financial plan.

26. The bank computing system of claim 22, wherein the reward is vested over the vesting period by:
determining a first vesting time within the vesting period; and
vesting a first portion of the reward at the first vesting time.

27. The bank computing system of claim 26, wherein vesting the reward over the vesting period further comprises:
determining a second vesting time within the vesting period, wherein the second vesting time is after the first vesting time; and
vesting a second portion of the reward at the second vesting time.

28. The bank computing system of claim 26, wherein the first portion of the reward is refrained from vesting before the first vesting time.

29. The bank computing system of claim 22, wherein the reward is vested over the vesting period by allowing a vested and uncollected portion of the reward to be collected, the vested and uncollected portion of the reward corresponding to the one of the first interactive elements selected by the user.

30. The bank computing system of claim 29, wherein the processing circuit is further configured to:
receive the collection user request by the financial institution computing system via a network from the user device, the collection user request corresponding to a vested and uncollected portion of the reward; and
add the vested and uncollected portion of the reward to at least one account associated with the user of the user device in response to the collection user request to collect the vested and uncollected portion of the reward.

31. The bank computing system of claim 22, wherein the at least one reward parameter and the collection user request is received by the financial institution computing system via a network from the user device.

32. The bank computing system of claim 22, wherein the processing circuit is further configured to:
receive a monitor request from the user device; and
cause the user device to display one or more of:
an amount of the reward;
the vesting schedule indicating at least one vesting time and amount of at least one portion of the reward to be vested;
a vested amount of the reward;
an unvested remainder of the reward;
an option to accelerate the at least one vesting time of the at least one portion of the reward to be vested; or
an option to increase the unvested remainder of the reward.

33. The bank computing system of claim 22, wherein the processing circuit is further configured to:
receive at least one time-modifying parameter; and
modify at least one of a length of the vesting period or vesting time at which a portion of the reward vests in the vesting period.

34. The bank computing system of claim 22, wherein the processing circuit is further configured to:
receiving at least one amount-modifying parameter; and
modifying amount for an unvested remainder of the reward or a portion of the reward to be vested.
